(19) United States
(12) Patent Application Publication
(10) Pub. No.: US 2019/0111437 A1
(43) Pub. Date: Apr. 18, 2019

(54) RECEPTACLE FOR ONE OR MORE SAMPLE CONTAINERS

(71) Applicants: Baxalta Incorporated, Bannockburn, IL (US); Baxalta GmbH, Zug (CH)

(72) Inventors: Gabriela PRODINGER, Wien (AT); Martin PILLIATER, Wien (AT)

(73) Assignees: Baxalta Incorporated, Bannockburn, IL (US); Baxalta GmbH, Zug (CH)

(21) Appl. No.: 16/097,127

(22) PCT Filed: Apr. 24, 2017
(86) PCT No.: PCT/EP2017/059624

§ 371 Date: Oct. 26, 2018

(30) Foreign Application Priority Data
Apr. 27, 2016 (EP) 16167226.6

(51) Int. Cl. B01L 9/06

(52) U.S. Cl. CPC B01L 9/06; B01L 2200/025

(57) ABSTRACT

The invention relates to a holder, in particular a cleaning device, for receiving at least one preferably elongate sample container, in particular a cuvette, which has an opening and a bottom opposite the opening in a longitudinal direction and closing the sample container, for cleaning such a sample container, wherein the holder is provided with a first element for at least partially abutting in the longitudinal direction against an edge of the opening of the sample container, the edge facing towards the longitudinal direction, wherein the first element has a passage which is configured in such a way that it at least partially overlaps with the opening of the sample container when the sample container is received, and which is configured, when the sample container is received, to introduce and discharge fluid through the opening for cleaning the sample container, and has a second element, which is essentially opposite the first element in the longitudinal direction, for at least partially abutting in the longitudinal direction against the bottom of the sample container, the first and second elements being arranged in such a way that the sample container is held between the first and second elements, in particular clamped in between the first and second elements in the longitudinal direction.

### TECHNICAL FIELD

The invention concerns a holder (receptacle, receiving means) for sample containers, in particular elongated sample containers such as cuvettes or test tubes. Such holders can be used in particular for cleaning sample containers.

### PRIOR ART

Sample containers such as cuvettes or test tubes are usually made of quartz glass or glass and are relatively expensive. They are re-used and must be cleaned clean and residue-free before being used again. They are often blown dry with compressed air.

During the cleaning and drying processes, sample containers are usually held individually in the hand, wherein gloves need to be worn and there is a high risk that a sample container breaks during manual cleaning. At best, with sufficient skill, for example, two cuvettes can be held simultaneously with one hand. Manual cleaning is therefore extremely time-consuming.

Commercially available cleaning devices such as the “Vakuwash” device of Bel-Art-Products or the “P 65” device series of Firefly Science suck in a cleaning liquid from a storage container by applying a vacuum, which cleaning liquid sprays through a nozzle into the interior of the sample container. In addition, the outer wall of the sample container can be washed or cleaned with the cleaning liquid from a spray bottle or the like. The used cleaning liquid is collected in an Erlenmeyer flask. Such cleaning devices can hold a maximum of two cuvettes and require a vacuum pump. When cleaning residues of harmless sample solutions, such as those found in the food and bio-chemical industries, these cleaning devices do not offer satisfactory time savings and a sufficient safety gain over manual washing/cleaning.

### SUMMARY OF THE INVENTION

It is therefore an object of the present invention to provide a holder for sample containers with a simple construction, which holder can be used in particular for cleaning the sample containers, whereby the sample containers can be easily accommodated in the holder, remain safely and reliably accommodated and can easily be removed. The holder should preferably be configured in such a way that the sample containers can be cleaned reliably and cleanly. Preferably, it should also be possible to hold several sample containers so that cleaning can be carried out simultaneously.

According to the invention, this object is solved by the holder according to claim 1.

Accordingly, a holder, in particular a cleaning device, is provided for receiving at least one preferably elongate sample container, in particular a cuvette, which has an opening and a bottom opposite the opening in a longitudinal direction and closing the sample container, for cleaning such a sample container, wherein the holder has a first element for at least partially abutting in the longitudinal direction against an edge of the opening of the sample container, the edge pointing in the longitudinal direction, wherein the first element has a passage which is configured in such a way that it overlaps at least partially with the opening of the sample container when the sample container is received, and is configured, when the sample container is received, to introduce and discharge fluid through the opening for cleaning the sample container, and has a second element, which is in the longitudinal direction substantially opposite to the first element, for at least partially abutting in the longitudinal direction against the bottom of the sample container, the first and second elements being arranged in such a way that the sample container can be held between the first and second elements, in particular clamped between the first and second elements in the longitudinal direction.

The invention is based on the idea of holding one or more sample containers in the longitudinal direction between first and second elements by way of the first and second elements abutting against opposite sides of the sample container. The first element abuts the opening of the sample container in such a way that the edge of the opening is in contact with the first element in the longitudinal direction. On the opposite side of the opening, the bottom abuts against the second element. The sample container is held in this way between the first and second elements in the longitudinal direction, in particular with a form-fit, and is preferably clamped between the first and second element in the longitudinal direction.

In the area of the opening of the sample container, the first element has a configuration such that fluid for cleaning, for example cleaning liquid and compressed air, can be introduced into the sample container and then be discharged again through the opening and through the passage, when the sample container abuts the first element. In other words, the passageway in the first element allows cleaning fluid to be injected into the sample container through the opening in the sample container while the sample container is being held, to bounce against the bottom of the sample container, and to emerge again through the opening and the passageway. Cleaning fluid can therefore enter and exit through the opening of the sample container and the passage in the first element, especially simultaneously.

Thus, cleaning can be carried out with sufficient accuracy and residue-free, while the sample container is safely and firmly held in the holder. This allows, for example, cleaning fluid or compressed air to be introduced at increased pressure, without the handling of the sample container or several sample containers being problematic. Thus, the present invention can achieve a safe reception or accommodation of sample containers, and when using the holder for cleaning, a thorough and reliable cleaning for a residue-free re-use of the sample containers is made possible.

This invention is suitable for a wide variety of cuvettes or test tubes or, in general, for in particular elongated sample containers with an opening and an opposite bottom. This invention is particularly suitable for cuvettes with stopper caps or screw caps. The base area of the cuvettes in a cross-section perpendicular to the longitudinal direction of the cuvettes may in particular be square.

The use of the holder according to the invention for cleaning sample containers is also being conceived. A cleaning device may have the holder according to the invention. In particular, it may have a unit for dispensing cleaning fluid and/or a unit for applying compressed air.

Further particularly advantageous embodiments of the invention are indicated in the dependent claims.

In a preferred embodiment, the first element at the passageway has at least partially a recess in the longitudinal direction, the recess having a greater width than a width of the passageway in a direction perpendicular to the longitudinal direction. The width of the recess shall be such that a portion of the sample container can be received longitudinally in the recess substantially around the opening of the sample container. Preferably, the recess and the passage are formed as a step, with the sample container abutting against the recess in a lateral direction perpendicular to the longitudinal direction and the edge of the opening abutting the recess in the longitudinal direction. This embodiment enables the sample container to be accommodated even more precisely and reliably in the holder, since in particular a slipping of the sample container in a direction perpendicular to the longitudinal direction can be prevented by the accommodation in the recess.

In a preferred embodiment, the first element is essentially a plate and has a recess or bore that forms the passage. The recess can, for example, be in the form of a circular or oval milled-out portion.

In an alternative embodiment, the first element can have at least two rails running essentially parallel to each other and in a direction perpendicular to the longitudinal direction, so that the passageway is formed as a gap between the rails.

In particular, the distance between the rails is less than an outer diameter of the sample container along the direction of the distance between the rails so that the sample container can abut against the rails in the longitudinal direction.

In particular in the case of the embodiment with the rails, the holder according to the invention is suitable for simultaneously holding several sample containers along the direction in which the rails extend.

Preferably the first and/or second element has a spring device/means by which the sample container is pressed against the corresponding other second or first element by the spring device exerting a restoring force acting in the longitudinal direction. Preferably, the spring device is arranged such that when the spring device is pre-tensioned or biased in the longitudinal direction, the distance between the first and second elements for inserting the sample container is increased. On the one hand, the spring device simplifies the insertion and removal of the sample container, and on the other hand, the sample container can also be held more reliably in the holder by the at least slightly pretensioned spring clamping the sample container between the first and second elements.

The spring device may include a spring element arranged to be located on the side of the first and second elements facing the sample container when the sample container is received. Alternatively or additionally, a spring element may be arranged such that, when receiving the sample container, it is arranged on the side of the first or second element, which side is oriented away from the sample container.

In addition, the spring device may have a stamp movable in the longitudinal direction which stamp at least partially abuts against the sample container. The spring element, for example a spiral spring, may be arranged around the stamp.

The second element preferably has the spring device, in particular with the stamp, so that the bottom of the sample container can abut against the stamp.

Preferably, the holder can hold or receive several sample containers. For example, the sample containers can be arranged in a row in one direction perpendicular to the longitudinal direction. Multi-row arrangements are also conceivable.

A multi-row arrangement for the sample containers has the additional advantage that the holder has improved stability compared to a relatively narrowly configured holder with a single-row holder. The stability can be improved by means of cantilever arms.

In addition, it is conceivable that the holder has feet that allow the holder to be positioned without touching the support surface on which the holder is arranged, in particular the laboratory bench.

The holder can be pivoted so that the sample container received in the holder can be tilted. This is advantageous, as the inclination or tilting of the holder can cause residual cleaning fluid to run out of the sample container.

The components of the holder according to the invention must be resistant to cleaning fluids when used for cleaning. The cleaning liquids commonly used in the final cleaning step to remove the water include in particular ethanol and isopropanol, as these can be blown away evenly and without residue of compressed air. In the preferred embodiment, materials resistant to these cleaning fluids, such as plastics, are used. The first and second elements are therefore preferably made of polyethylene or polypropylene. Fluoropolymer plastics such as polytetrafluoroethylene or its copolymers are also preferred. The use of silicone rubber or fluoroelastomer is particularly advantageous for the stamp.

Further features and advantages of the invention will be described in more detail below.

### BRIEF DESCRIPTION OF THE DRAWINGS

FIGS. 1a and 1b show a first embodiment of the present invention in a front view and a side view;

FIGS. 2a and 2b show a second embodiment of the present invention in a front view and a side view;

FIG. 3 shows a top view of the first element of the first embodiment; and

FIG. 4 shows a top view of the first element of the second embodiment.

### DETAILED DESCRIPTION OF THE DRAWINGS

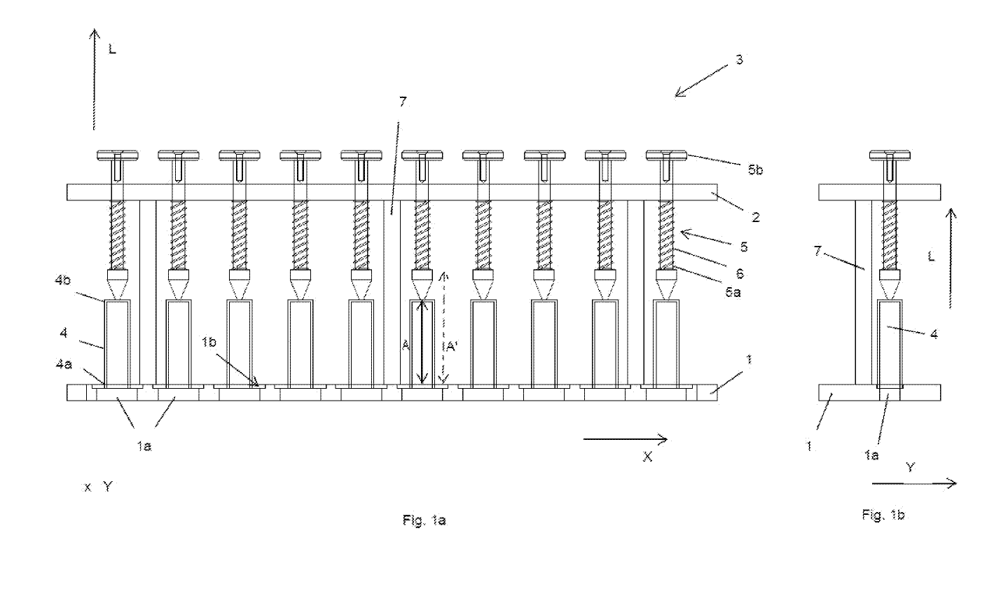

Preferred embodiments of the present invention are described in detail below with reference to the accompanying FIGS. 1 to 4.

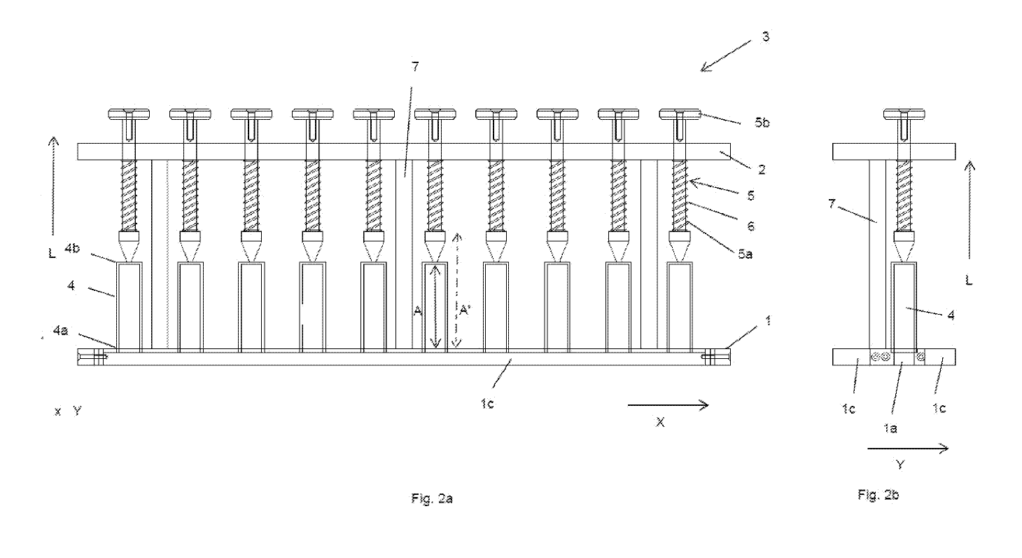

In FIGS. 1a and 2a, the longitudinal direction L and the X-direction perpendicular to it run within the drawing plane, and the Y-direction runs into the drawing plane.

In FIGS. 1b and 2b, the longitudinal direction L and the Y-direction perpendicular to it run within the drawing plane, and the X-direction runs into the drawing plane.

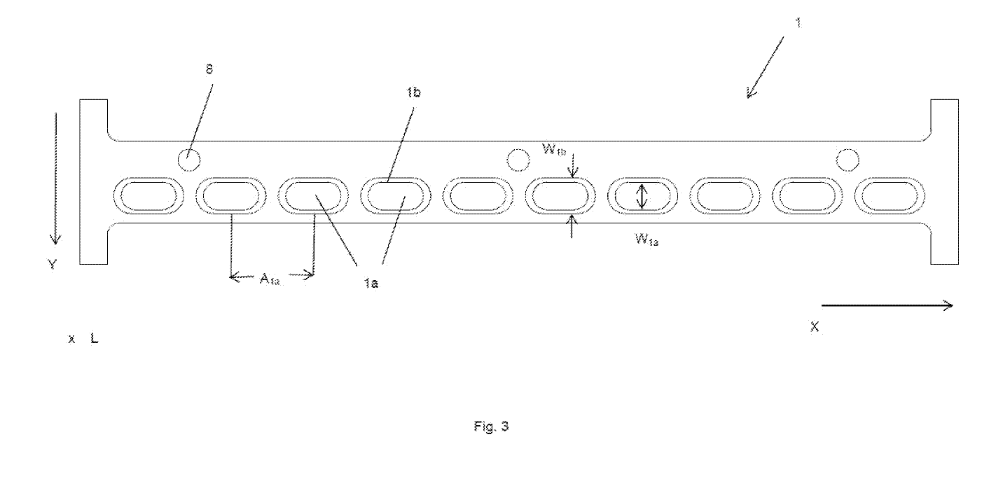

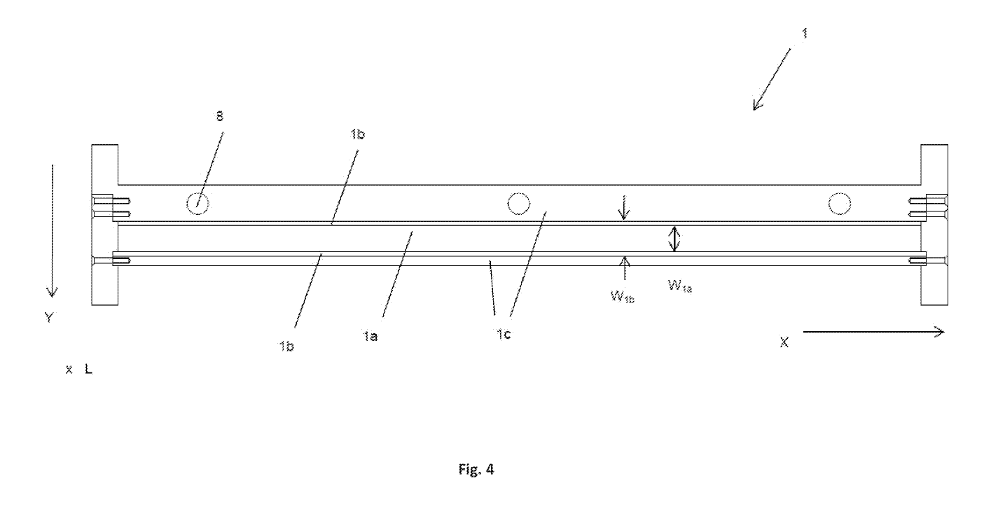

In FIGS. 3 and 4, the Y and X directions run within the drawing plane, and the longitudinal direction L runs perpendicular to the drawing plane.

FIGS. 1a and 2a show the FIG. 3 of the invention in a front view. Longitudinal sample containers 4, in particular cuvettes, which have an opening 4a at one end and a base 4b at the opposite end, are accommodated in the holder 3. The sample container 4 is particularly elongated in the longitudinal direction L.

The holder 3 has a first element 1 which, in the first embodiment shown in FIG. 1a, is essentially plate-shaped, and passages 1a are formed as recesses in the first element 1. The second element 2 may also have a plate and is substantially opposite the first element 1 in the longitudinal direction.

The second element 2 has a spring means/device 5 comprising a plurality of stamps 5a, each of which may abut against the bottom 4b of a sample container 4 in the longitudinal direction L. The stamp 5a is movable in the longitudinal direction L and, in the embodiment shown in FIG. 1a, can be moved through the plate of the second element 2 in the longitudinal direction L by pulling the handle 5b in the longitudinal direction L.

The first 1 and the second 2 elements are connected by connecting elements 7 extending in the longitudinal direction L.

A spring element 6 is provided around the stamp 5 in such a way that the spring element 6, in particular a spiral spring, is biased in the longitudinal direction L when the handle 5b is moved out of the holder 3. When the handle 5b is pulled out, the stamp 5a is moved away from the plate of the first element 1 in such a way that the distance A, which is present between the plate of the first element 1 and the stamp 5a in the longitudinal direction L when the spring element 6 is received, is increased to the distance A′, for example.

The spring element 6 is at least slightly pre-tensioned or biased when a sample container 4, i.e. at distance A, is mounted. When stamp 5a is pulled out at distance A′, the sample container 4 can be easily inserted or removed.

FIG. 3 shows that the passage 1a is formed as a recess in the plate of the first element 1. Passage 1a can be circular or oval, but can also have a different shape. The passage la is in the embodiment of FIGS. 1 and 3 at least partially surrounded by a recess 1b on the side facing towards the sample container 4. The recess 1b represents, together with the surface of the plate of the first element 1 facing towards the side of the sample container 4 and the passage 1a, a step, at which the sample container can abut in the area of the opening 4a. The width W₁ₐ of passage 1a, for example in the Y direction, is smaller than the width W_{1b} of recess 1b in the Y direction. The width W_{1b} must be adapted to the respective sample containers to be accommodated, more precisely the outer diameter of the sample containers.

The distance between the several passages 1a in the X-direction is A₁ₐ. The distance A₁ₐ must be set so that good handling is ensured and that also as many sample containers as possible can be accommodated in the holder at the same time.

The plate of the first element 1 has connection points 8, in particular holes, for the connection elements 7.

In the second embodiment shown in FIGS. 2 and 4, the holder, preferably instead of the recesses 1a and the plate of the first element 1, has two rails 1c which are essentially parallel to each other and run in the X direction. The space or gap between the rails, i.e. the distance or width W₁ₐ between the rails, forms the passage 1a. The rails 1c may have a recess 1b on the sides where they face each other (in the Y-direction), which recess is formed as a step in a cross-section of the rail 1c along the Y-direction. Moreover, the second embodiment (or FIGS. 2a, 2b and 4) corresponds to the first embodiment (or FIGS. 1a, 1b and 3), which is illustrated by the use of the same reference signs.

According to the invention, cleaning fluid may be introduced through the passage la into sample container 4, while the sample container 4 is contained in holder 3. The cuvette 4 indicated in the figures is square in shape and has a slit-shaped opening 4a. This opening 4a overlaps with the passage 1a, when the sample container 4 is accommodated in the holder 3. Through the opening 4a and the passage 1a, cleaning fluid can be introduced into the sample container 4 and can in particular at the same time exit again, while the sample container 4 is accommodated in the holder 3.

Preferably, the holder 3 or the cleaning device with the holder 3 according to the invention is arranged in such a way that the opening of the sample container 4 faces towards the support, in particular a laboratory bench, on which the holder is positioned. The second element is then positioned vertically above the first element.

### LIST OF REFERENCE SIGNS

1 First element
1a Passage
1b Recess
1c Rail
2 Second element
3 Holder
4 Sample container
4a Opening
4b Bottom
5 Spring device
5a Stamp
5b Handle
6 Spring
7 Connecting element
8 Connection point or bore hole
W_{1b} Width of recess in Y-direction
W₁ₐ Width of the passage in Y-direction
A, A′ Distance in longitudinal direction
A₁ₐ Distance of neighbored passages in X direction
L Longitudinal direction
X,Y Directions perpendicular to the longitudinal direction and perpendicular to each other.

1. Holder (3), in particular cleaning device, for receiving at least one preferably elongate sample container (4), in particular a cuvette, having an opening (4a) and a base (4b) which is opposite the opening in a longitudinal direction (L) and closes the sample container during the cleaning of the sample container, the holder comprising:
a first element (1) for at least partially abutting in the longitudinal direction against an edge of the opening (4a) of the sample container, the edge facing towards the longitudinal direction (L), the first element (1) having a passage (1a) which is configured such that it at least partially overlaps with the opening (4a) of the sample container when the sample container (4) is received, and which is configured to introduce and discharge fluid through the opening for cleaning the sample container when the sample container (4) is received, and
a second element (2), which is in the longitudinal direction (L) substantially opposite to the first element (1), for at least partially abutting in the longitudinal direction against the bottom (4b) of the sample container,
wherein the first (1) and second (2) elements are arranged such that the sample container (4) can be held between the first (1) and second (2) elements, in particular clamped between the first (1) and second (2) elements in the longitudinal direction (L).

2. Holder according to claim 1, wherein the first element (1), on the side facing towards the sample container (4), has at the passage (1a) a recess (1b) in the longitudinal direction (L) with a larger width (W1b) than a width (W1a) of the passage (1a) in a direction (Y) perpendicular to the longitudinal direction (L), and the first element (1) is configured such that at least one portion at the opening (4a) of the sample container can be received substantially in the recess (1b) in the longitudinal direction (L).

3. Holder according to claim 1 or 2, wherein the passage (1a) is formed as a recess and/or bore in the first element (1).

4. Holder according to claim 1 or 2, wherein the first element (1) has at least two rails (1c) running essentially parallel to one another and in a direction (Y) perpendicular to the longitudinal direction (L), and the passage (1a) is formed as a space between the rails (1c).

5. Holder according to one of the preceding claims, wherein the first (1) and/or second (2) element has at least one spring device (5) for pressing the sample container (4) against the other element (1, 2) by a restoring force acting in the longitudinal direction (L), the spring device (5) preferably being configured in such a way that, by biasing the spring device (5) in the longitudinal direction (L), the distance (A) between the first (1) and second (2) element can be increased.

6. Holder according to claim 5, wherein the spring device (5) has at least one spring element which, when the sample container (4) is received, is arranged towards a side of the first or second element, which side is oriented towards the sample container (4), and/or has a spring element which, when the sample container (4) is received, is arranged on a side of the first (1) or second (2) element, which side is oriented away from the sample container (4).

7. Holder according to claim 5 or 6, wherein the spring device (5) has a stamp (5a) movable in the longitudinal direction (L) for at least partially abutting against the sample container (4).

8. Holder according to one of the preceding claims, which is arranged for simultaneously receiving a plurality of sample containers (4), which are arranged in a row along a direction (X) perpendicular to the longitudinal direction (L).

9. Holder (3) according to one of the preceding claims, which is pivotable in such a way that the sample container received in the holder can be inclined.

10. Use of the holder (3) according to one of the preceding claims for cleaning the sample container, wherein cleaning fluid is introduced into the sample container (4) and discharged from the sample container (4) through the opening (4a) and the passage (1a).
